(19) United States
(12) Patent Application Publication
(10) Pub. No.: US 2005/0261961 A1
(43) Pub. Date: Nov. 24, 2005

(54) Linear newspaper methodology

(75) Inventors: Jay G. Bernhardt, Liverpool, NY (US); William Gates, Sun Lakes, AZ (US)

Correspondence Address: BERNHARD P. MOLLDREM, JR., 224 HARRISON STREET, SUITE 200, SYRACUSE, NY, 13202, US

(73) Assignee: Jay G. Bernhardt and William Gates

(21) Appl. No.: 11/130,358

(22) Filed: May 16, 2005

Related U.S. Application Data
(60) Provisional application No. 60/572,248, filed on May 19, 2004.

(51) Int. Cl. G06F 17/60

(52) U.S. Cl. 705/14

(57) ABSTRACT

A linear newspaper methodology involves news gathering, selling of advertising, and distributing or circulating the printed newspapers along a linear corridor. Favorably, the corridor has as its axis a trunk highway with unlimited access such as a scenic by-way, or lakeshore or beach highway, passing from village to village. The newspapers are printed at a central location along the corridor. There are linear news reporting zones and linear advertising sales areas along the corridor. The corridor may also have short excursions to nearby historic sites and scenic areas.

This application claims priority of Provisional Patent Application No. 60/572,248, filed May 19, 2004.

### BACKGROUND OF THE INVENTION

This invention is directed to newspapers and to methods of publishing and distributing same, including news-gathering, sales of advertising, arrangement of the text onto the printed page, and distribution of the papers to readers. The invention is more specifically concerned with a linear newspaper, in which the news, advertising and distribution occur along a corridor that is defined by a generally linear axis, such as a stretch of highway or thoroughfare, or a canal or scenic rail line, and the land that is located within a few miles on either side of the highway, thoroughfare, or other axis.

The present invention is a departure from the conventional “circular” pattern observed in conventional newspaper publishing, in which there is a central or core urban area, e.g., a city or metropolitan area, and other zones that radiate our in all directions from the core area. The traditional zoned or circular approach to newspaper publishing and distribution limits the flexibility of the newspaper or other publication when the area of concern is laid out more or less linearly.

### SUMMARY OF THE INVENTION

In a preferred embodiment, the linear corridor can comprise a stretch of highway, e.g., 80 miles to 130 miles in length, with a width of about ten miles, i.e., approximately five miles (more or less) on either side of that highway. In some cases, the linear corridor may be much longer. The main highway axis or trunk route should be a normal trunk highway with unlimited access, and with homes, businesses, villages and farms right on the highway, as opposed to a limited access road such as an Interstate highway. Favorably, the roadway can have a distinctive character, such as a designation as a “Scenic By-way” or perhaps a lakeshore or beach highway, which may join a number of beach communities. The axis of the corridor could be a waterway, such as a river or canal, e.g., New York's Erie Canal. In any event, the various villages, hamlets, and cities along the highway share a sense of commonality or community. The linear highway does not have to be entirely straight, but may have one or more short diversions to a nearby historic site, scenic area, or other attraction.

The newspaper can favorably be published at a home office at a town, village, or city located about halfway along the roadway or corridor. News can be gathered on a regular basis by full time reporters or part-time reporters (i.e., “stringers”) each located in a respective reporting zone along the linear corridor, and these reporters would cover news that is local to their zones. The news can include local high school sports or college sports, local police and fire news, local government news, and other news of local interest. These reporters send in their stories to the home office, e.g., by email or via an Internet connection. Advertising sales staff are each responsible for a linear advertising area along the linear corridor, and sell advertising space to the businesses along the highway in their area. The advertising staff send their advertising copy, e.g., by email also to the home office. Favorably, the home office may be at a midway point along the corridor. The printed newspapers are distributed from the central office to newspaper distribution points along the stretch of highway, and the newspapers can be delivered to homes and businesses and also sold by individual newspaper to travelers and others along the highway.

The newspaper will include, in each edition, timely local news of all varieties, plus cultural and historical articles, so that the newspaper will be of great interest not only to the permanent residents and businesses along the corridor but also to travelers and visitors.

As a means of ensuring maximum readership interest, the arrangement of stories and articles in each day's or week's edition can vary from one geographic zone to another along the corridor. For example, the papers printed for distribution to the westernmost zone(s) can have that zone's high school sports news articles placed at the top or front of the sports section, and those for the more easterly zones located below that article. Likewise, other zones would have the article about their local high school sports teams positioned at the top in the copies distributed in their zone, with the other sports articles below, and so forth across the corridor. Each zone could have its local sports news at the top of that zone's sports page or section. This can be carried out automatically at the home office, using publishing and page setting software. Of course, other news and features as well as advertising can also be positioned favorably for the readers in each respective geographic zone along the linear corridor.

### BRIEF DESCRIPTION OF THE DRAWING

FIG. 1 is a map illustrating the geographical considerations of one embodiment of this invention.

FIG. 2 is a chart schematically illustrating news coverage zones of this embodiment.

FIG. 3 is a chart illustrating advertising sales territories of this embodiment

FIG. 4 illustrates the position of printed news or sports reports in the linear newspaper of this embodiment which may vary from zone to zone.

### DETAILED DESCRIPTION OF A PREFERRED EMBODIMENT

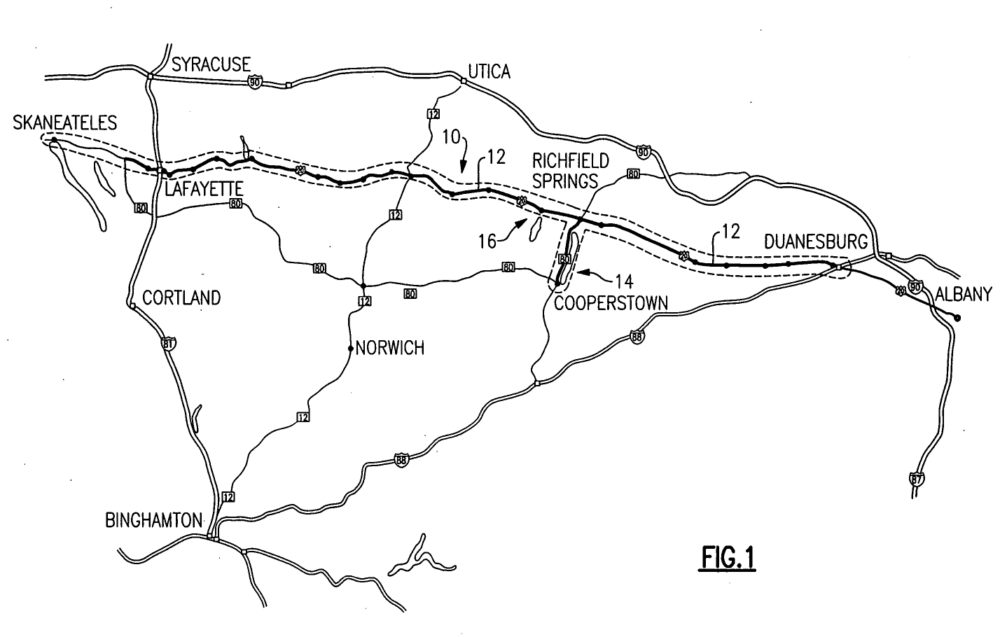

FIG. 1 is a map illustrating one favorable example of a geographic linear corridor (10) in which this invention can be employed. Here, the linear corridor (10) has as its axis, a non-limited trunk highway, namely, a stretch (12) of US Highway 20 that extends from Skaneateles, N.Y., at its western extreme to Duanesburg, N.Y., at the east. Also included is a southward thumb or extension (14) along a short stretch of road extending south from US Route 20 to Cooperstown, N.Y. (home of the Baseball Hall of Fame, as well as many other attractions). There are a number of attractions, or “Destination Points” along the corridor. The linear corridor (10) has a coverage area extending about five miles north and south of US Route 20, as indicated with dash lines, and a corridor of similar width on the thumb or extension (14) that goes south to Cooperstown, N.Y. US Route 20 here is a highway without limited access, passing directly from village to village and going through, or next to many scenic and historic areas. In this example, there are no large cities. The nearest major cities (Syracuse, Utica, Schenectady, and Albany, N.Y.) are all located well off the rather narrow corridor (10). This stretch (12) of US Route 20 has unlimited access, that is, motorists can start or stop at any point along it, as opposed to a so-called limited access road or expressway, such as the New York State Thruway or an Interstate highway, in which there are only a few, limited points of exit and entry, and in which any commercial establishments or points of interest are removed at least some distance from the road.

In this embodiment, the central newspaper offices (16) are located in Richfield Springs, N.Y., about halfway along this stretch (12) of Route 20. The news is edited here, and the printing of the papers is coordinated here. The newspapers are then distributed east and west to the readership along the various points in the corridor (1O). As shall be discussed later, there may be a number of regional editions (40(1); 40(2); etc.) which may vary slightly from one zone to the next. The variance relates to the positioning of various local news items so that the news (or sports) of particular concern to that zone is featured in a more prominent part of the news or sports page in that region. The various newspaper editions are all transported from the central location (16) to the distribution points within the respective zones and from there to the retailers or customers in each zone.

FIG. 2 shows schematically one favorable arrangement of the reporting coverage zones (20(1); 20(2); . . . 20(N)) here extending end-to-end across this stretch (12) of US Route 20. These zones (20(1); 20(2); . . . 20(N)) may overlap. One or more reporters would be responsible for gathering news in each zone (20(1); 20(2); . . . 20(N)) and sending their stories and articles, with any accompanying photos or images, e.g., via Internet (22) to the home office (16). These reporters may include students, educators, business persons, clergy, or others with an interest in reporting events in their local coverage areas.

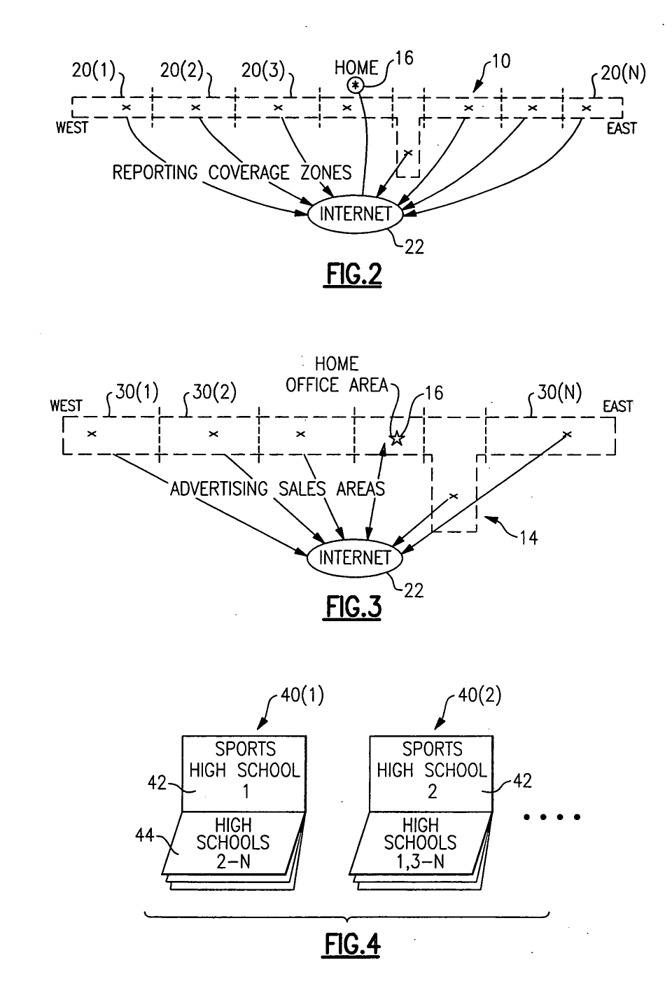

FIG. 3 illustrates a linear arrangement of advertising sales areas or territories (30(1); 30(2); . . . 30(N)) along this linear corridor, The advertising sales staff may be the same persons who are reporters, or may be advertising sales persons exclusively or have other duties. The staff sales member for each area (30(1); 30(2); . . . 30(N)) can transmit advertising data and advertising copy in person, by messenger, by email or over Internet (22) to the home office. Billing for advertising can be done automatically, with the advertising fees based on newspaper distribution (i.e., readership), which may be weighted for the respective zone.

The news can be arranged so that each zone's edition (40(1); 40(2); etc.) of the paper has pages printed especially for the respective zone (20(1); 20(2); . . . 20(N)) with the local news or articles that feature the local zone being prominently located on the page(s). The same news would be in each zone's copies, but positioned differently for the other zones. For example, as illustrated in FIG. 4, the edition (40(1)) for first zone can have its high school sports news (i.e., High School 1) printed on the sports page in a prominent area (42) above the area (44) where news about other high school teams is printed. Each other zone would have its editions (20(2), etc.) of the same paper printed with the respective high school sports team's news (e.g., High School 2, etc.) located at the upper area (42) of that zone's sports page, as shown. Other news articles or subjects could be similarly treated.

Classified ads in the linear paper can also be arranged in linear geographical order, within each classification or category; which helps both buyers and sellers. That is, for a given category of advertised goods or services, in the zone 1 edition (20(1)), the ads for zone 1 would appear first, then for zone 2, zone 3, and so on. For the zone 2 edition (20(2)), the zone 2 ads would appear first. For the westernmost zone, zone N, that edition (20(N)) would have the ads geographically in reverse order, i.e., zone N, then zone N−1, etc. The actual order would be optimized to best serve the advertisers and readers.

Other advertisements, i.e., display advertisements can be printed prominently in the merchant advertiser's own zone or region, and in another, less prominent position in the editions for other regions. This positioning of the advertising material can all be carried out automatically at the central newspaper offices, based on the merchant's location and preferences as entered by the respective advertising sales staff person.

Because of the linear nature of the news gathering and publishing methodology, the natural growth pattern for the newspaper would be linearly, that is further along Route 20 in this example. Here, one possible pattern of growth would be westerly past Skaneateles, NY, into New York State's Finger Lakes region, and beyond. There could also be a second diversion or extension from the main thoroughfare to another destination point, i.e., historic site or scenic area.

The linear newspaper concept here is implemented for a monthly newspaper, i.e., published and distributed once a month. However, the concept is not limited only to a monthly, and could be a newspaper that is published weekly, twice weekly, bi-weekly, or daily.

The newspapers are distributed to residents and businesses along the corridor, and also to convenience stores, motels, and other merchants along that route for sale to tourists and visitors.

While the invention has been described with reference to one preferred embodiment, the invention is not limited to that embodiment. Rather many modifications and variations would appear to persons of ordinary skill in the art, without departing from the scope and spirit of the invention which is to be defined by the appended Claims.

1. A linear newspaper publication methodology, comprising gathering news along a linear corridor that is defined by a thoroughfare extending at least through a number of communities along the thoroughfare, and which extends a limited distance out from the thoroughfare; selling advertising in the paper to advertisers who are located within said linear corridor; printing copies of the newspaper containing said news and advertising; and distributing the newspapers along said linear corridor.

2. The linear newspaper methodology of claim 1 wherein said corridor comprises a linear series of news reporting zones, and said news is gathered within each of said zones respectively.

3. The linear newspaper methodology of claim 1 wherein said corridor comprises a linear series of advertising sales areas, and advertising in the paper is sold to businesses located within said advertising sales areas, respectively.

4. The linear newspaper methodology of claim 1 wherein the thoroughfare of said linear corridor comprises a trunk highway with unlimited access.

5. The linear newspaper methodology of claim 1 wherein said thoroughfare includes a stretch of a trunk highway of about 80 to 130 miles in length.

6. The linear newspaper methodology of claim 5 wherein said corridor has a width not exceeding an average of about 10 miles.

7. The linear newspaper methodology of claim 5 wherein said corridor includes a short diversion from said thoroughfare to a nearby historic or scenic site.

8. The linear newspaper methodology of claim 2, wherein said newspapers are printed in respective editions for said zones, with news relating to each respective zone being featured in a prominent news area in the edition for that zone, and with news relating to other areas being printed in another news area in that edition.

9. The linear newspaper methodology of claim 2, wherein said corridor also comprises a linear series of advertising sales areas, with advertising in the paper being sold to businesses located within said advertising sales areas, respectively, and wherein advertisements for said businesses are printed in different respective locations within editions of said papers that are distributed to the respective zones.

10. The linear newspaper methodology of claim 9, wherein classified advertisements are arranged in a linear geographical order by zone.

11. The linear newspaper methodology of claim 10, wherein the edition for each zone has a different geographical order for said classified advertisements.
